(19) United States
(12) Patent Application Publication
(10) Pub. No.: US 2013/0169153 A1
(43) Pub. Date: Jul. 4, 2013

(54) REALTIME COMPUTER CONTROLLED SYSTEM PROVIDING DIFFERENTIATION OF INCANDESCENT AND LIGHT EMITTING DIODE LAMPS

(71) Applicants: Reggie Meeks, Fort Wayne, IN (US); Timothy Bomya, Westland, MI (US)

(72) Inventors: Reggie Meeks, Fort Wayne, IN (US); Timothy Bomya, Westland, MI (US)

(21) Appl. No.: 13/822,928

(22) PCT Filed: Sep. 13, 2010
(86) PCT No.: PCT/US10/48621

§ 371 Date: Mar. 13, 2013

(51) Int. Cl. H05B 37/02

(52) U.S. Cl. CPC H05B 37/02
USPC 315/77; 307/9.1

(57) ABSTRACT

A motor vehicle electrical power system includes a light source powered from an electrical power source. At key on the light source is tested to determine operational readiness and the type of the light source. At key on the switch is cycled to apply a pulse width modulated energization to the light source. A reference copy of the pulse width modulated signal is available. A comparator having first and second inputs provides a comparison of the pulse width modulated signal applied to the light source and reference. Variation in the rate of change of voltage across the light source may be compared with the reference to characterize the light source as a light emitting diode or another type of source, usually an incandescent bulb.

### BACKGROUND

1. Technical Field

The technical field relates generally to impedance measurement and more specifically to application of impedance measurement to identify which from a known set of possible loads is connected to a power supply circuit.

2. Description of the Problem

Motor vehicle lighting systems may employ different types of light sources, including incandescent bulbs, arc lamps and light emitting diodes, among other devices. Low voltage light sources such as some types of incandescent bulbs and light emitting diodes can be directly energized from a body controller, allowing easy implementation of electronic switching and bulb monitoring. However, doing so introduces the possibility that the character of the load supported by the body controller may change over the life of a given vehicle or from vehicle to vehicle equipped with similarly programmed body controllers.

Incandescent lamps are energized by connecting the bulbs to a voltage source. Their service life may be adversely affected by application of an over voltage. Light emission in terms of lumens radiated may be adjusted by connecting additional radiators to the circuit. Light emission from light emitting diodes may be adjusted by changing the current sourced to the device. Incandescent lamps have been viewed as resistive loads and their operational status has been readily confirmed by detection of current flow through their circuit. If just operational availability is at issue light emitting diodes may be checked the same way. Lighting circuit integrity has been verified on vehicles by application of an electrical voltage pulse to each lighting circuit at least at key-on of a vehicle. To date this is believed to have been limited to simply verifying current flow commensurate with operational availability of known device.

However, incandescent lamps and light emitting diodes are to some extent complex devices with an imaginary axis component in their response to application of a voltage. An incandescent bulb is a hot coil and a light emitting diode is a cold PN junction. Thus an incandescent lamp exhibits some inductance. Application of a voltage across a light emitting diode results in generation of a static electric field and thus the device should exhibit some characteristics of a capacitor. The complex load vectors for the respective devices have distinctive, detectable components.

U.S. Pat. No. 7,030,627 to Ashley teaches that complex impedances are commonly measured with electronic test equipment. The complex impedance at any specific frequency consists of a real resistive component and a reactive portion.

### SUMMARY

A motor vehicle electrical power system includes a light source powered from an electrical power source. A control switch provides for connection of the light source to the electrical power source. Control over the connection may be implemented in a way to deliver power as a pulse width modulated signal in order to control the total current delivered and thus the illumination intensity. At key-on of the vehicle ignition or some other defined start point a vehicle's light sources are tested to determine operational readiness and the types of the light sources. At key-on the light sources are cycled by application of pulse width modulated energization signal. Reference copies of the pulse width modulated signals are available. A comparator having first and second inputs provides a comparison of the pulse width modulated signal applied to a given light source and its reference signal. Variation in the rate of change of voltage across the light source may be compared with the reference to characterize the light source as a light emitting diode or another type of source, usually an incandescent bulb. Light source operation may be automatically adjusted to allow for changes in the type of light source installed on the vehicle, including provision of pulse width modulated energization to provide illumination level control. The system is implemented in digital format and resolution control for analog to digital conversion is affected by selection of the duration of the pulse width modulated signal.

### BRIEF DESCRIPTION OF THE DRAWINGS

FIG. 1 is a high level schematic of a vehicle electrical power generation, storage and distribution system.

FIG. 2 is detailed schematic of a light emitting diode switching circuit.

FIG. 3 is a detailed schematic of an incandescent bulb switching circuit.

FIG. 4 is a high level flow chart illustrating operation of an embodiment of the system.

### DETAILED DESCRIPTION

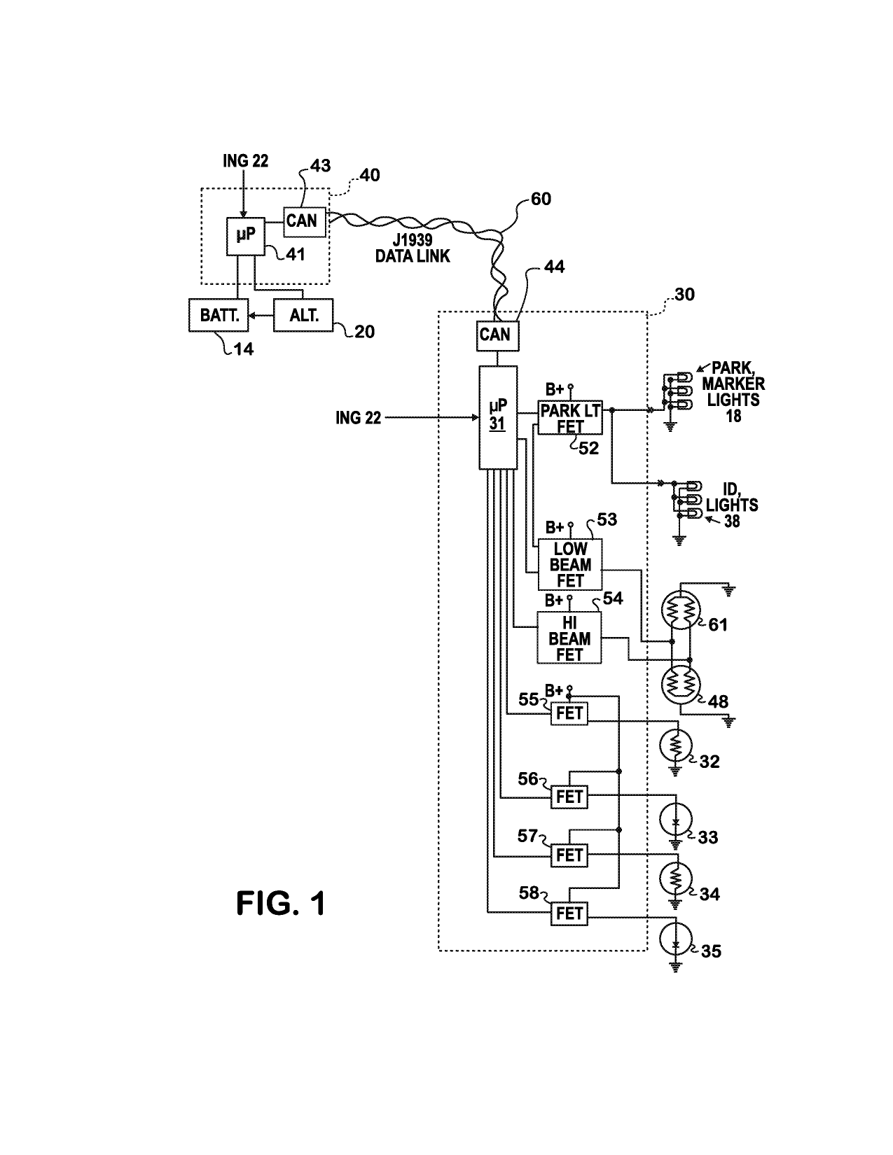

Referring to FIG. 1, a high level schematic of elements of a vehicle electrical control system 10 related to control over a plurality of lamps 12 is illustrated. External lamps are more typically monitored for operational integrity than internal lamps, however the principals of the system disclosed here are applicable to diverse systems as long as the qualitative operating characteristics of possible loads are known. The elements of the vehicle electrical control system 10 shown include a body controller 30, an engine controller 40 and a serial data link 60 over which the body controller 30 and the engine controller 40, among other controllers, communicate data using controller area network (CAN) interfaces 44 and 43, respectively. The body controller 30 and the engine controller 40 each include a programmable microcontroller. For the engine controller 40 this is microcontroller 41. For the body computer 30 it is microcontroller 31.

Body controller 30 is a high level controller which, among other functions, provides for switching control over the vehicle lamps 12 including, by group: the low beam headlight filaments 61; the high beam headlight filaments 48; the parking marker lights 18; identification (ID) lights 38; the left front turn signal lamps; the right front turn signal lamps; the right rear turn signal lamps; and the left rear turn signal lamps; etc.

The lamps 12 are usually light emitting diodes (LEDs) or incandescent bulbs. Here, by way of example only, the park marker lights 18 and ID lights 38 are LEDs and the dual filament headlamp bulbs 48 and 61 are incandescent bulbs. The headlamps or course are not limited to being incandescent bulbs. Light radiators 32, 33, 34 and 35, either LED or incandescent in character, may be used to provide the turn signal lamps or other exterior lights. The park marker lights 18, ID lights 38, low beam filaments 61, high beam filaments 48 and the light radiators 32-35 are turned on and off by switching of the conductive state of a plurality of switches/switch circuits incorporated into the body controller 30. The plurality of switches may be implemented in field effect transistor (FET) switch circuits 52, 53, 54, 55, 56, 57 and 58 under the control of the microcontroller 31.

Electrical power may be supplied to lamps 12 from an electrical power system including a battery 14 and an engine driven alternator 20. Voltage levels on the battery and power output from the alternator 20 may be monitored by the engine controller.

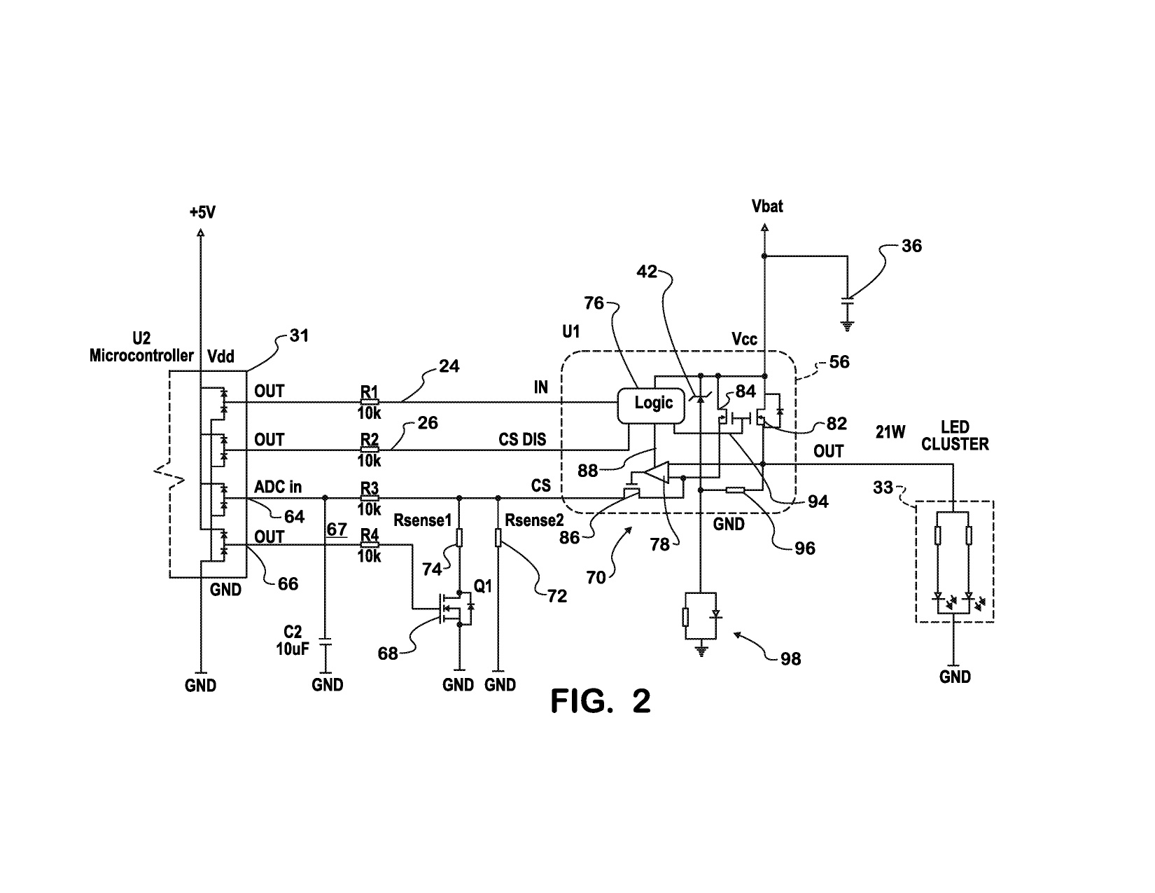

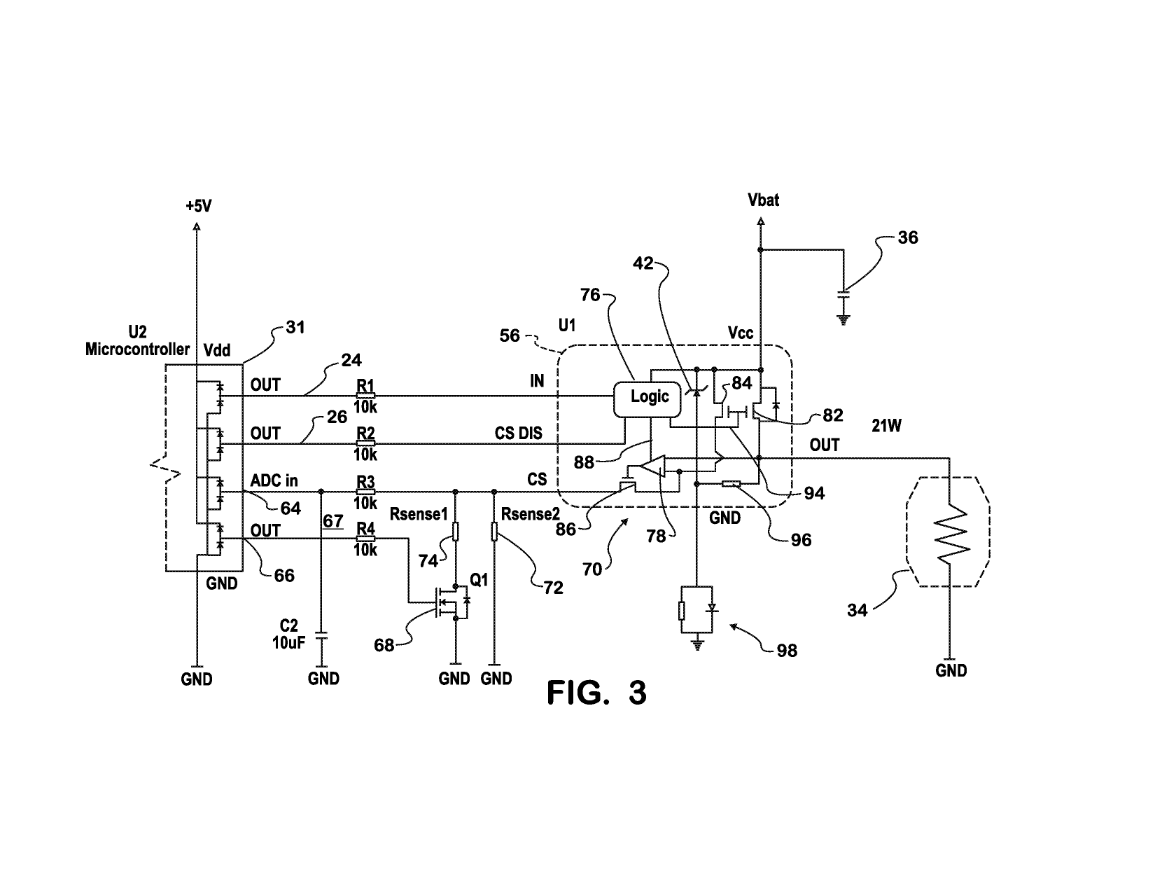

Body controller 30 may receive a signal from an ignition switch 22 directly over the controller area network serial data link 60 from a gauge controller (not shown) or over the serial data link 60 from engine controller 40. The body computer includes a microcontroller 31 which may be programmed to test exterior lamps connected to body controller 30 following a state change of the ignition from off to on. Microcontroller 31 may be configured to apply an electrical pulse to each external lamp upon occurrence of ignition on and to check for current flow in response thereto (See FIGS. 2 and 3).

FIGS. 2 and 3 provide increased detail of the FET switch circuits 52-58. Using FET switch circuits 56, 57 as representative examples the connections between FET switching circuits 52-58 to microcontroller 31 and to a light radiator 33, 34 are illustrated. FET switch circuits 52-58 provide power to lamps 12 and can be cycled to provide a pulse width modulated (PWM) signal which produces characteristic responses from a load depending upon whether the load is an incandescent bulb, a diode, a ballast for a florescent device, some other type of load or whether the load has failed operationally. The response can be compared to a reference signal and used to generate signals for return to the microcontroller 31 indicative of the character and operational readiness of each light radiator connected to an FET switch circuits.

Referring particularly to FET switch circuit 56 (FET switch circuit 57 is similar except for connection to a incandescent light radiator 34), an LED based light radiator 33 is connected to the source of MOSFET 82 and receives energization through the MOSFET 82 from a direct current power source. A second MOSFET 84 is connected by its drain to the same power source and is connected by its source to the reference input of a comparator 78. The source of MOSFET 82 is connected to the second input of comparator 78 and by way of a resistor.

FET switch circuit 56 receives input signals from microcontroller 31 over a control input line 24 and a clock input line 26. FET switch circuit 56 includes a logic circuit 76 which receives power from a battery input and which is connected to receive the control input and the clock signal input from microcontroller 31. Logic circuit 76 operates on the signals to provide the gate signal which in turn controls the conductive state of two power switching MOSFETs 82, 84 and to provide a clock signal for comparator 78 over clock line 88. The source of MOSFET 84 is relatively isolated from the source of MOSFET 82 for short duration PWM signals and the signal level on the source of MOSFET 82 will reflect the response of the load, be it LED light radiator 33 or incandescent light radiator 34. The output of MOSFET 84 becomes a reference signal against which the response of the light source load to the cyclic signal is compared.

The output of comparator 78 is connected to the gate of a field effect transistor (FET) 86. The drain of FET 86 is connected to the source of MOSFET 84 and thus the signal level on the drain of FET 86 tracks the signal level on the reference input of comparator 78. The drain of FET 86 is connected a feedback line 64, which includes a resistor, to microcontroller 31. Collectively comparator 78 and FET 86 form an analog to digital (A/D) converter 70 which provides in a serial output a digitized representation of the response of light radiator 33 to energization.

Connected between feedback line 64 and ground is an A/D gain control circuit 62 which comprises a pair of resistors 72, 74, connected in parallel between the feedback line 64 and a gain control MOSFET 68 connected in series with resistor 74 which controls conduction through resistor 74. In other words, there are two gain values for A/D converter 70, and the gain is changed by reducing the resistance between the feedback line 64 and ground by placing gain control MOSFET 68 into conduction to allow current flow through resistor 74 which reduces the resistance of the A/D gain control circuit 62. Microcontroller 31 selects the gain for gain control circuit 62 by setting the value on gain control line 66.

MOSFET 82 is used to connect LED light radiator 33 through the source of the MOSFET to a direct current power, typically the vehicle battery or alternator, to generate light or to disconnect the light radiator from the direct current power to cease the generation of light. In addition, MOSFET 82 connects to one input of a comparator 78 and signals received on this input reflect the response of light radiator 33 as a load. MOSFET 84 is connected by its source to a reference input of comparator 78 and by its drain to the source of direct current power. In the conductive state of MOSFET 84 the direct current power supply is connected to the reference input of comparator 78 to the source of direct current power. If light radiator 33 is non-conductive, potentially due to its failure, than the signals appearing at the sources of power by MOSFETs 82, 84 (and to the inputs of compartor 78) when the power MOSFETs are in conduction should be synchronous and identical. The conduction of power MOSFETs 82, 84 may be driven by use of pulse width modulated signals over a gate output line 94 from control logic 76 for the purpose of determining if the load represented by the light radiator has an inductive component or a capacitive component. Where there is an inductive component associated with an incandescent load initial current flow should be low and voltage high when compared with initial current flow through a light emitting diode, which has a capacitive component. Serialization of the response of the light radiator to a gating pulse applied to power MOSFET 82 is compared with a reference value passed by power MOSFET 84 with a sufficient degree of resolution to allow incandescent loads to be distinguished from diode loads without determining quantitative values for inductive and capacitive loads. Variation of the duration of the pulse (in other words PWM) may be used for isolating particular types of loads, particularly depending upon the output characteristics for light radiators used for particular applications.

A zener diode 42 connected between the drains of power MOSFETs 82, 84 to a protective circuit 98 protects the MOSFETs and control logic circuit 76 from overvoltage conditions. The drain of power MOSFET 82 is connected by a resistor 96 to the protective circuit 98. The feedback line 64 includes a resistor and capacitor for pulse shaping network 67. A capacitor 36 supports voltage levels from the direct current power source when the power MOSFETs 82, 84 switch on.

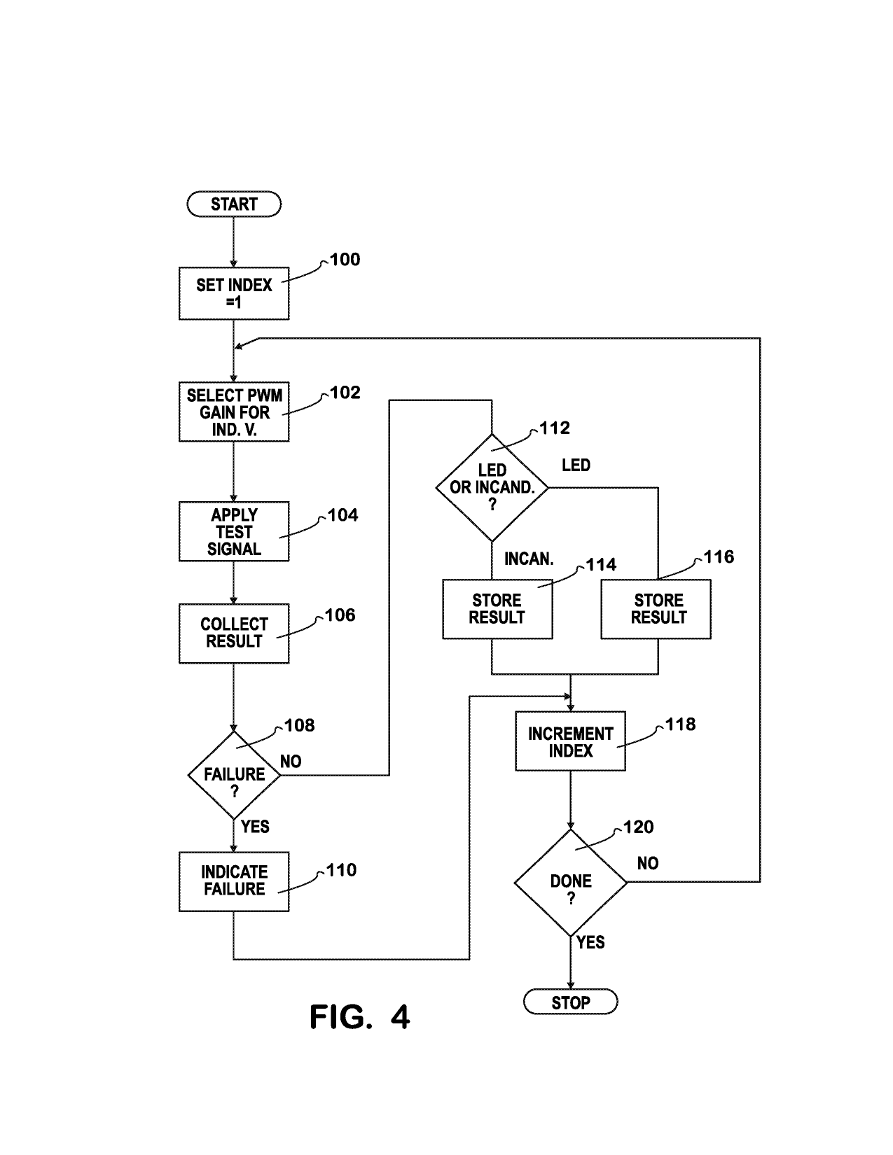

FIG. 4 is a high level flow chart which illustrates execution of a routine after a change in keyswitch/IGN position to ON. For purposes of illustration it is assumed that each illumination position to be checked is illustrated as referenced by an index number and that at least two different types of light radiator can be installed at some position. The types of light radiators exhibit differing complex impedances. Upon initialization of the routine the index value is set equal to 1 (step 100) and the process begins. At step 102 a pulse width value appropriate for testing the possible complex loads at a given location (referenced by the index value). The selection step 102 also comprehends selection of a gain value for the A/D converter 62. This may involve a simple state value for control of gain control MOSFET 68. More than pulse width value (and gain value) may be used if the test for a given location is run more than once to generate additional data for evaluating the load. Next, at step 104, the test signal(s) (and gains) are applied to the FET switch circuit 56 and the A/D gain adjustment circuit 62. At step 106 the result(s) (the output of the A/D converter) are collected.

Step 108 provides for failure detection. Typically a failure will be indicated by a string of all “1's” or all “0's” from the A/D converter 70. If this occurs a failure is indicated (step 110). Thereupon the index is incremented and the routine returned to step 102. Another result is likely indication of data which can be used to determine what kind of light radiator is installed at the index location.

At step 112 the data string(s) are analyzed to determine what kind of light radiator is attached. Here two possibilities are given, incandescent and light emitting diode. Steps 114 and 116 provide for storing the type of light radiator to storage. Power MOSFET 82 may be operated differently depending upon the type of radiator attached to it. Generally an incandescent source is energized using a voltage source, and during operation power MOSFET 82 is simply held on. However, an LED device is characterized by a constant voltage drop and is energized by a current source. In order to allow control over current sourced to the LEDs the power MOSFET 82 may be cycled on and off, hence the character of the device is stored to inform later control over power MOSFET 82. After storing the results the index is incremented (step 118) and it is determined if the operation is completed (step 120). If not the process returns to step 102.

Complex impedances associated with particular types of loads can be qualitatively detected using numerous techniques. While a particular method, amenable to a digital control environment, has been discussed, other techniques may be employed and under circumstances where the qualitative character of the load is known may be used for quantitative evaluation.

A complex impedance expected expected to exhibit capacitive characteristics, such as exhibited by a light emitting diode, may be detected using a multiplexer and series resistor to make a Thevenin sine wave source. The phase relationship of current to voltage across a capacitor is well known and may be detected across the series resistor.

Analog quantitative analysis of detection of a filament (incandescent) lamp may be implemented by including a resistor of known resistance in the controller module in series with the lamp and varying the frequency to find the circuit's series RL resonant frequency. Finding the resonant frequency will allow determination of the maximum through current and will indicate the lamp inductance. Similarly a known inductance may be place in series with a LED and the resonant frequency for the series RLC circuit found to provide the current maximum and thereby indicate the capacitance of the LED.

Parallel or series resonant frequency measurements may allow switch in of a step up transformer to supply internal 110 or 220 volts AC where the appropriate load is detected. The body controller may be used to provide an AC inverter operating at 60 or 50 Hz.

Tunable capacitors and inductors may be used to implement the resonant frequency detection described above. A tunable inductance like characteristic may be implemented using a gyrator (voltage adjustable complex impedance).

Electrically erasable programmable memory (EEPROM) or other long term storage systems may be used to record measurements for future reference. Life testing may be implemented by comparing present values for components over properties exhibited upon installation.

What is claimed is:

1. A vehicle electrical system, comprising:
an electrical power source;
a replaceable load having predictable qualitative characteristics;
a switch controlling connection of the replaceable load to the electrical power source;
means for cycling application of an energization signal to the replaceable load in response to a change in state of the switch;
a comparator having first and second inputs, the first input being connected to an input of the light source for monitoring the response of the light source to application of the energization signal; and
the second input of the comparator being connected to a source of a reference signal.

2. A vehicle electrical system as set forth in claim 1, further comprising:
the replaceable load being a light source; and
means for cycling including means for generating a pulse width modulated energization signal.

3. A vehicle electrical system as set forth in claim 2, further comprising:
a serial analog to digital converter connected to an output from the comparator;
a gain control sub-circuit connected to the output from the serial analog to digital converter.

4. A vehicle electrical system as set forth in claim 3, further comprising:
the source of the reference signal being a second switch under control of the means for cycling.

5. A vehicle electrical system as set forth in claim 4, further comprising:
a controller for the switch and for the gain control sub-circuit for providing signals setting the period for the pulse width modulated signal and a level of gain for the serial analog to digital converter.

6. A vehicle electrical system as set forth in claim 5, the means for cycling further comprising:
a microcontroller; and
a logic circuit connected to receive a control signal and a clock signal from the microcontroller, the logic controller providing gate signals for controlling the first and second switches.

7. A vehicle electrical system as set forth in claim 6, further comprising:
the first and second switches being power MOSFETs.

8. A vehicle electrical system as set forth in claim 7, further comprising:
the light source exhibiting capacitive or inductive characteristics upon application of the pulse width modulated signal, or, alternatively to exhibiting capacitive or inductive characteristics, exhibiting a failure mode.

9. A vehicle electrical system as set forth in claim 8, further comprising:
means responsive to detection of a light source exhibiting capacitive characteristics for configuring the microcontroller to control current delivered to the light source during periods when energized for illumination.

10. A vehicle electrical system as set forth in claim 3, wherein the resolution of the serial analog to digital converter is responsive to the clock signal.

11. A method of characterizing a load connected to a vehicle electrical control system based on its inductive or capacitive attributes, the method comprising the steps of:
selecting a duration for a pulse width modulated test signal;
applying at least a first pulse width modulated test signal of the selected duration to the load;
supplying a reference pulse width modulated signal of the selected duration;
comparing the first pulse width modulated test signal as measured at an input of the load with the first reference pulse width modulated signal;
responsive to a relative delay in a rate of voltage increase in the first pulse width modulated test signal relative to the first reference pulse width modulated signal characterizing the load connected to the vehicle electrical control system as a light emitting diode;
responsive to a match of the first pulse width modulated test signal to the reference pulse width modulated signal indicating a load failure; and
otherwise characterizing the load as a source other than a light emitting diode.

12. A method as set forth in claim 11, comprising the further steps of:
applying additional pulse width modulated test signals of other selected durations.

13. A method as set forth in claim 12, comprising the further steps of:
providing analog to digital conversion of result of the comparison step; and
adjusting the resolution of the providing step responsive to the selected duration of the pulse width modulated test signal.

14. A method as set forth in claim 13, the method being applied to a motor vehicle and occurring in response to key on.

15. A motor vehicle electrical power system comprising:
a light source;
an electrical power source for energizing the light source;
a power MOSFET connected between the electrical power source and the light source to control over connection of the light source to the electrical power source;
a vehicle ignition key;
a microcontroller responsive to key on of the vehicle ignition key for selecting at least a first duration for a pulse width modulated test signal for application to the light source and a pulse width modulated reference signal;
a controller responsive to selection of the duration for first pulse width modulated test signal for applying a gate signal to the power MOSFET to produce for generating the first pulse width modulated test signal; and
a comparator connected to receive the first pulse width modulated test signal and the reference signal and generating a comparison signal for return to the microcontroller.

16. A motor vehicle electrical power system as set forth in claim 15, further comprising:
a serial analog to digital converter connected to receive the comparison signal; and
the controller providing resolution control of the serial digital converter responsive to the duration.

17. A motor vehicle electrical power system as set forth in claim 16, further comprising:
a gain control circuit connected between the microcontroller and the serial analog to digital converter.

18. A motor vehicle electrical power system as set forth in claim 16, further comprising:
the microcontroller being responsive to the comparison signal for selecting pulse modulated signal sets for energization of the light source for illumination.
